(19) United States
(12) Patent Application Publication
(10) Pub. No.: US 2007/0275607 A1
(43) Pub. Date: Nov. 29, 2007

(54) Compensation for far end crosstalk in data buses

(76) Inventors: Young Hoon Kwark, Chappaqua, NY (US); Christian Schuster, Yorktown Heights, NY (US)

Correspondence Address: KEUSEY, TUTUNJIAN & BITETTO, P.C., 20 CROSSWAYS PARK NORTH, SUITE 210, WOODBURY, NY, 11797, US

(21) Appl. No.: 11/418,346

(22) Filed: May 4, 2006

(51) Int. Cl. H01R 24/00

(52) U.S. Cl. 439/676

(57) ABSTRACT

A method and device for crosstalk compensation includes evaluating skew for lengths of the two electrical paths. An integrated circuit is coupled to the two electrical paths, and the integrated circuit includes a global crosstalk compensation element integrated therewith which globally compensates for crosstalk on all lengths of portions of the two electrical paths.

### BACKGROUND

1. Technical Field

The present invention relates to high-speed electrical data communication links, and more particularly to applications in personal computers, servers, switches, and routers where multiple data communication links are routed in parallel arrangements (e.g., buses).

2. Description of the Related Art

A typical data communication link used in, e.g., a server includes one or more electrical data buses which may connect a transmitting chip with a receiving chip. The electrical bus may be routed over solder balls, plated through holes (vias) and wires (often configured as transmission lines such as microstrips or striplines) which all affect the electrical performance of the communication link.

A key metric of the performance is the amount of crosstalk, i.e., undesired coupling of signal energy from one interconnect to the other. This coupling takes place due to the physical proximity of solder balls, vias, and wires. In particular, the crosstalk between a transmitter on one of the lines in the bus and a downstream receiver on another line in the bus (so called far end crosstalk) is detrimental to the quality of the received signals. Usually, this crosstalk increases with frequency and thus limits the maximum achievable data rate on the bus. This is especially true for interconnects using single-ended signaling.

Common measures to reduce crosstalk include differential signaling (the use of two adjacent interconnects to transmit one signal), ground shields, increasing the physical separation between adjacent conductors, passive and active crosstalk compensation. Crosstalk compensation in general refers to any structure, device, or (complex) circuitry that introduces energy coupling between interconnects of opposite polarity to partially cancel out the undesired crosstalk. Crosstalk compensation is usually done in close spatial proximity to the location where the crosstalk occurs, e.g., in a connector or on-chip, and may be repeated at several locations along the communication link.

### SUMMARY

A method and device for crosstalk compensation includes evaluating skew for lengths of the two electrical paths. An integrated circuit is coupled to the two electrical paths, and the integrated circuit includes a global crosstalk compensation element integrated therewith which globally compensates for crosstalk induced on all portions of the two electrical paths.

Another method for crosstalk compensation includes evaluating skew to maintain skew between two electrical paths below a threshold, providing a chip coupled to the two electrical paths, the chip including a global crosstalk compensation element integrated therewith, globally compensating for crosstalk over all portions of electrical lengths of the two electrical paths using the global crosstalk compensation element, and tuning the global crosstalk compensation element in accordance with the two electrical paths.

A circuit in accordance with the present principles includes at least two electrical paths, and an integrated circuit connected to the at least two electrical paths. A tunable global crosstalk compensation element is integrated with the integrated circuit and connected to the two electrical paths. The global crosstalk compensation element is configured to globally compensate for crosstalk over all portions of electrical lengths of the two electrical paths whether the electrical lengths are on or off the integrated circuit.

These and other objects, features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a diagram showing a printed circuit board arrangement with at least one chip including a global compensation element in accordance with an illustrative embodiment;

FIG. 2 is a schematic diagram showing an example of mutual inductance crosstalk between two communication links;

FIG. 3 is a schematic diagram showing an example of mutual inductance crosstalk between two communication links including local compensation;

FIG. 4 is a plot showing far end crosstalk (FEXT) magnitude (dB) versus frequency for the original bus of FIG. 2 and for the FEXT reduced bus with local compensation in FIG. 3;

FIG. 5 is a plot showing magnitude of transmission (dB) versus frequency for the original bus of FIG. 2 and for the FEXT reduced bus with local compensation in FIG. 3;

FIG. 6 is a schematic diagram showing the example of FIG. 3 where additional transmission line links are disposed between the mutual inductance element producing crosstalk and a global compensation capacitor between the two communication links;

FIG. 7 is a plot showing far end crosstalk (FEXT) magnitude (dB) versus frequency for an original bus without global compensation for crosstalk and for the FEXT reduced bus with global compensation in FIG. 6;

FIG. 8 is a plot showing magnitude of transmission (dB) versus frequency for an original bus without global compensation for crosstalk and for the FEXT reduced bus with global compensation in FIG. 6;

FIG. 9 is a plot showing far end crosstalk (FEXT) magnitude (volts) versus time (ns) for an original bus without global compensation for crosstalk and for the FEXT reduced bus with global compensation in FIG. 6;

FIG. 10 is a schematic diagram showing an example of a scattering parameter block including measured data for different communications links to simulate crosstalk between transmission line links using a global compensation element between the two communication links in accordance with the present invention;

FIG. 11 is a plot showing far end crosstalk (FEXT) magnitude (dB) versus frequency for a bus I configuration for an original bus without compensation for crosstalk and for the FEXT reduced bus with global compensation as simulated in FIG. 10 in accordance with the present invention;

FIG. 12 is a plot showing far end crosstalk (FEXT) magnitude (dB) versus frequency for a bus II configuration for an original bus without compensation for crosstalk and for the FEXT reduced bus with global compensation as simulated in FIG. 10 in accordance with the present invention;

FIG. 13 is a plot showing far end crosstalk (FEXT) magnitude (dB) versus frequency for a bus III configuration for an original bus without compensation for crosstalk and for the FEXT reduced bus with global compensation as simulated in FIG. 10 in accordance with the present invention;

FIG. 14 is a plot showing far end crosstalk (FEXT) magnitude (dB) versus frequency for a bus IV configuration for an original bus without compensation for crosstalk and for the FEXT reduced bus with global compensation as simulated in FIG. 10 in accordance with the present invention;

FIG. 15 is a schematic diagram illustratively showing varactors used for global crosstalk compensation in accordance with one embodiment;

FIG. 16 shows schematic diagrams having laser trimmable inductors used for global crosstalk compensation in accordance with another embodiment;

FIG. 17 is a plot showing far end crosstalk (FEXT) magnitude (dB) versus frequency for an original bus without compensation for crosstalk and for a FEXT reduced bus with global compensation as simulated by the simulator in FIG. 10 for a plurality of skews (−20 ps, no skew and +20 ps) in accordance with the present invention; and

FIG. 18 is a flow diagram showing an illustrative method for providing global crosstalk compensation in accordance with the present invention.

### DETAILED DESCRIPTION OF PREFERRED EMBODIMENTS

Embodiments described herein provide methods based on crosstalk compensation using simple on-chip elements (either at transmit or receive side). Advantageously, these embodiments do not require the compensation to be in close spatial proximity to the crosstalk location (“local compensation”) nor do these embodiments require the use of complex on-chip circuitry. The compensation is able to react to most of the far end-crosstalk (FEXT) that is generated between transmitting and receiving chips (“global compensation”) while using only simple on-chip elements. The on-chip elements can be designed and tuned such that different levels of crosstalk can be addressed by, e.g., programming the chip. Tight skew control within the electrical bus is preferable.

Embodiments of the present invention can take the form of a hardware embodiment or an embodiment including both hardware and software elements. In a preferred embodiment, the present invention is implemented in integrated circuits such as on semiconductor chips or printed circuit boards. However, embodiments may include any circuit prone to crosstalk.

The circuits as described herein may be part of the design for an integrated circuit chip, chip set or system of printed wiring boards and chips. Chip and/or board designs may be created in a graphical computer programming language, and stored in a computer storage medium (such as a disk, tape, physical hard drive, or virtual hard drive such as in a storage access network). If the designer does not fabricate chips, boards or the photolithographic masks used to fabricate chips and boards, the designer transmits the resulting design by physical means (e.g., by providing a copy of the storage medium storing the design) or electronically (e.g., through the Internet) to such entities, directly or indirectly. The stored design is then converted into the appropriate format (e.g., GDSII) for the fabrication of photolithographic masks, which typically include multiple copies of the chip design in question that are to be formed on a wafer. The photolithographic masks are utilized to define areas of the wafer (and/or the layers thereon) to be etched or otherwise processed.

The resulting integrated circuit chips or boards can be distributed by the fabricator in raw wafer form (that is, as a single wafer that has multiple unpackaged chips), as a bare die, or in a packaged form. In the latter case the chip is mounted in a single chip package (such as a plastic carrier, with leads that are affixed to a motherboard or other higher level carrier) or in a multichip package (such as a ceramic carrier that has either or both surface interconnections or buried interconnections). In any case the chip is then integrated with other chips, discrete circuit elements, and/or other signal processing devices as part of either (a) an intermediate product, such as a motherboard, or (b) an end product. The end product can be any product that includes integrated circuit chips, ranging from toys and other low-end applications to advanced computer products having a display, a keyboard or other input device, and a central processor.

Far end crosstalk at a receiver chip is the sum of all coupling events along a bus. In many applications, the crosstalk sums up to one dominant pulse that has the duration of the rise/fall time of the signal. Conditions that would prevent the build-up of a dominant pulse include, e.g., multiple, strong reflections. This one dominant pulse can be compensated, to a large extent, by a simple, on-chip passive element at one specific location. Suggested locations are on-chip, either on the transmitter or the receiver side. This is in contrast to methods which try to counteract each coupling event along the bus and are hence much more costly and complicated to implement. Also, on-chip compensation can be tuned and is hence adaptable to the specific communication link at hand.

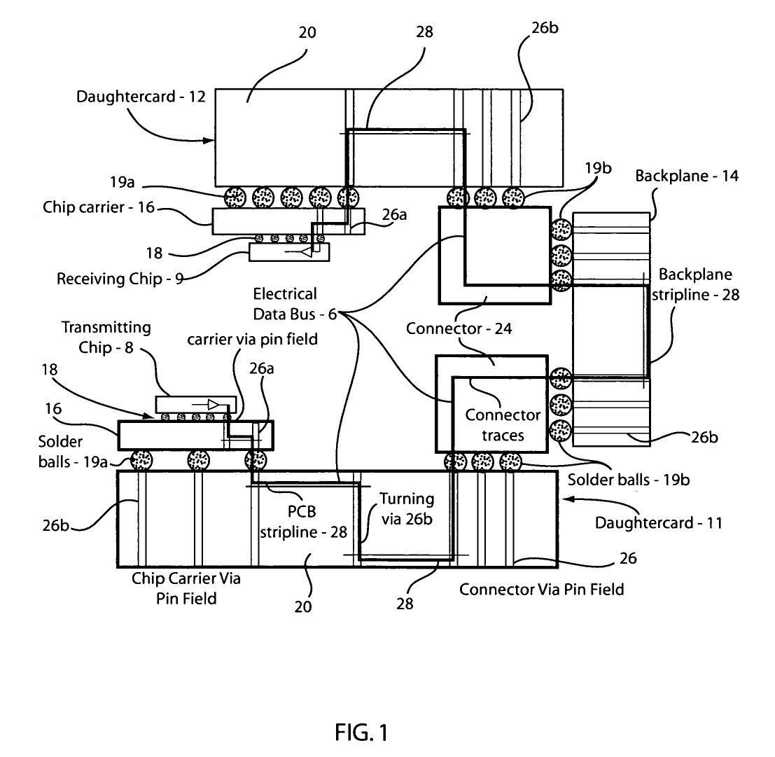

Referring now to the drawings in which like numerals represent the same or similar elements and initially to FIG. 1, illustrative elements of a data communication link in, e.g., a server are depicted. An electrical data bus 6 connects a transmitting chip 8 on daughtercard 11 with a receiving chip 9 on daughtercard 12 over a backplane 14. The chips 8 and 9 are mounted on chip carriers 16 with solder balls 18, and the chip carriers 16 are in turn mounted on printed circuit boards (PCBs) 20 (e.g., daughter cards 11 and 12) with solder balls 19a. Two connectors 24 join a backplane 14 with the daughtercards 11 and 12 using solder balls 19b. The electrical bus 6 is routed over solder balls 18, package vias 26a, solder balls 19a, through PCB vias 26b and wires (striplines or other transmission lines) 28 which all affect the electrical performance of the communication link.

Transmitting chip 8, receiving chip 9, backplane 14, or PCBs 20 may include a global compensation element as will described hereinafter. The global compensation element is preferably included in the receiving chip 9 although this element may be placed in one or more other locations, e.g., transmitting chip, PCBs etc. The global compensation element is preferably a single passive element integrated into a chip or board to reduce crosstalk for all pieces of the device/circuit. One advantage includes that if skew is evaluated to be maintained below a threshold, the passive compensation element can be employed to reduce crosstalk for all components in the path. Another advantage includes that the passive element may be placed in advance without a need to know all of he components in the system. A single passive element obviates the need for complex circuitry with active elements and reduces the amount of real estate needed to implement the cross talk compensation on a chip or board. For purposes of illustration, the inventive features depicted in the FIGS. will be presented with received circuitry (Rx); however, any other circuit may be employed.

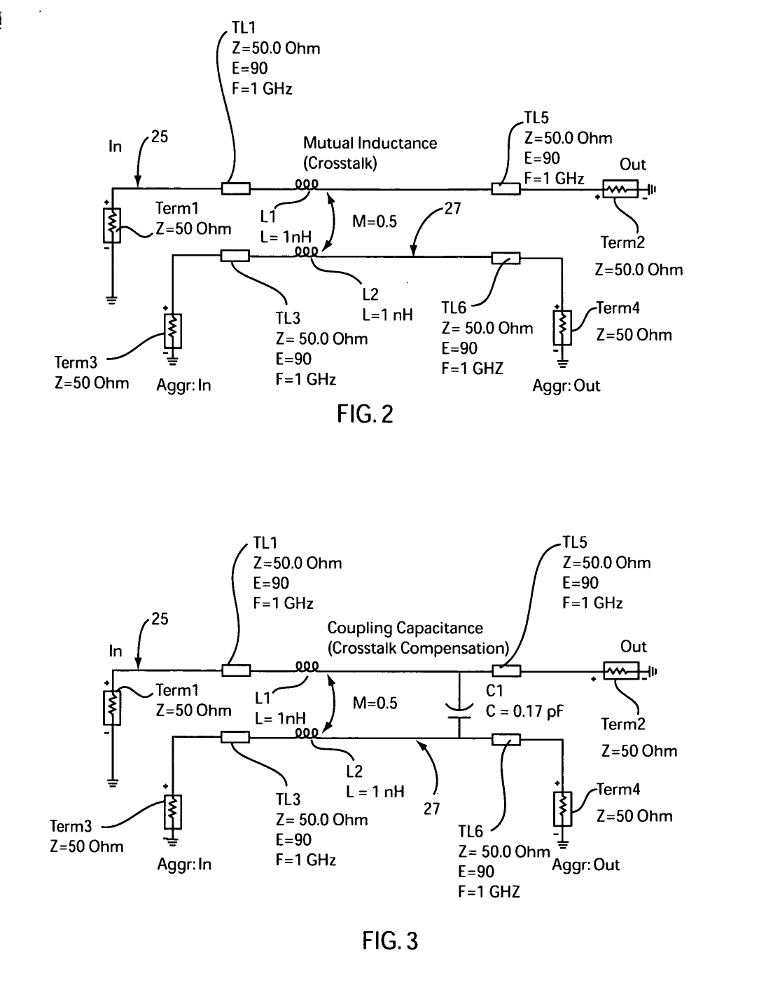

Referring to FIG. 2, an example of one crosstalk aggressor-victim pair for communication links is illustratively shown. The following abbreviations will be employed in the FIGS.: “Term” will be employed for terminations, “TL” for transmission lines, “L” for inductors and “C” for capacitors. “Z” is impedance, “E” is electrical length in degrees and “F” is frequency. Magnitudes and arrangements for electrical elements depicted in the FIGS. are for illustrative purposes only and may be changed or adjusted as needed by those skilled in the art.

Terminations, Term 1 and Term 2 belong to a victim interconnect 25. A first transmitter “In” is linked to a receiver “Out” via transmission lines TL1 and TL5. Terminations Term 3 and Term 4 belong to an aggressor interconnect 27. A second transmitter-receiver pair, “Aggr:In” and “Aggr:Out”, is routed over transmission lines TL3 and TL6, and couples to the first transmitter-receiver pair via a mutual inductance (M) between L1 and L2. The coupling results in far end crosstalk, i.e. part of “In” signals will be received by “Aggr:Out” (and part of “Aggr:In” signals will be received by “Out”). This far end crosstalk is detrimental to signal transmission. In this case (like in most cases in practice) the far end crosstalk is inductive (M).

Referring to FIG. 3, local capacitive crosstalk compensation is illustratively shown for far end crosstalk (FEXT). A capacitance C1 has been introduced between the two interconnects producing capacitive crosstalk/coupling which compensates the inductive coupling as described above. The value of C1 is chosen such that a maximum reduction over the frequency range of interest is achieved.

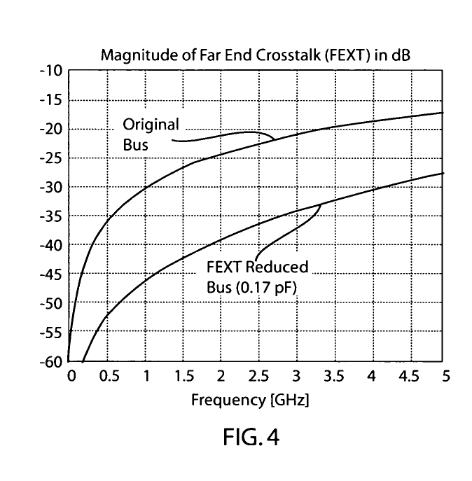

Referring to FIG. 4, a plot shows the FEXT reduction in frequency domain. The reduction in FEXT is accompanied by increased transmission as can be seen in FIG. 5.

The crosstalk compensation described above is well known in prior art. What is not described in the prior art is that simple, compensating elements do not have to be in close proximity to the crosstalk location nor do they have to be necessarily after the crosstalk location (which follows from reciprocity considerations) to achieve similar performance.

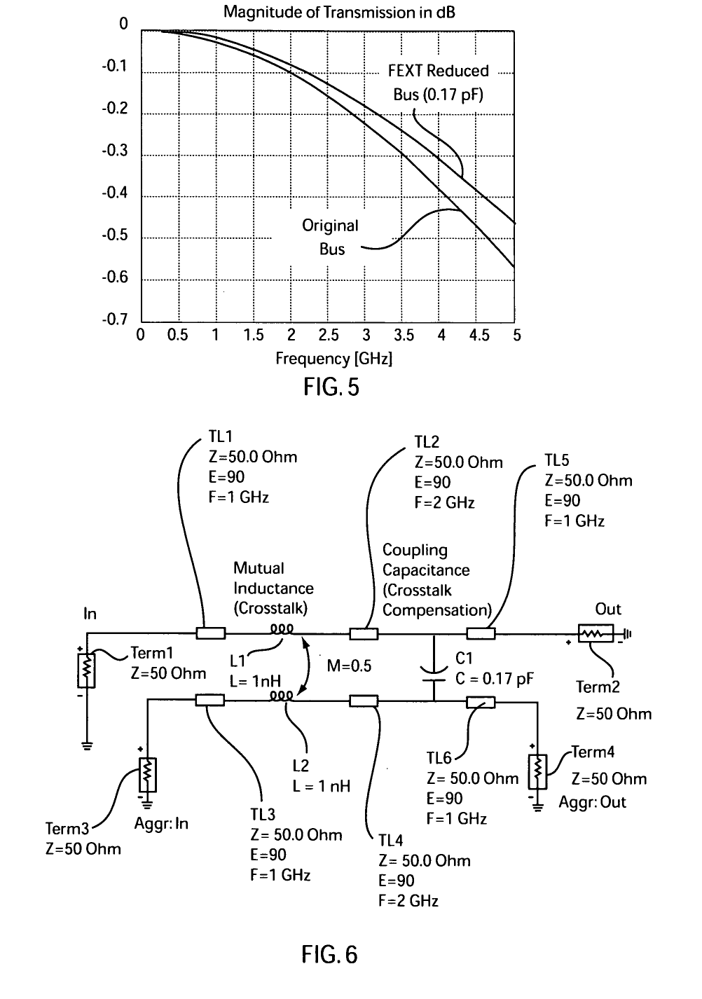

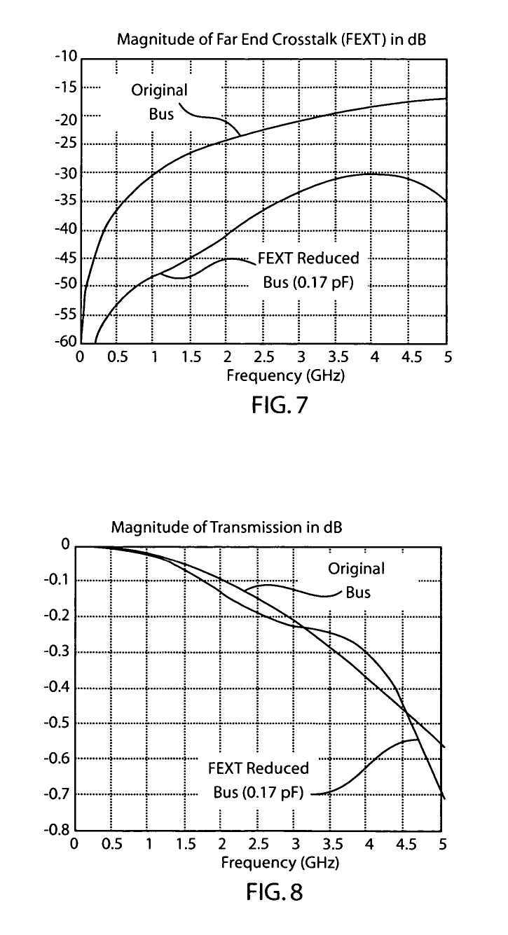

FIG. 6 shows the example of FIG. 2 with additional transmission lines TL2 and TL4 between the locations of crosstalk (M) and crosstalk compensation (C1). These transmission lines, TL2 and TL4, introduce a time delay that corresponds to a spatial separation in reality. FIG. 7 shows FEXT of the circuit in FIG. 6, and FIG. 8 shows the transmission of the circuit in FIG. 6. As can be seen in FIGS. 7 and 8, there is a substantial decrease in crosstalk with a high transmission level maintained. The oscillations in transmission (FIG. 8) are due to the reflections between the inductive crosstalk location (M) and the capacitive compensation (C1) location. These oscillations do not show up when the capacitance (C1) is located right next to the inductance M (“local compensation”).

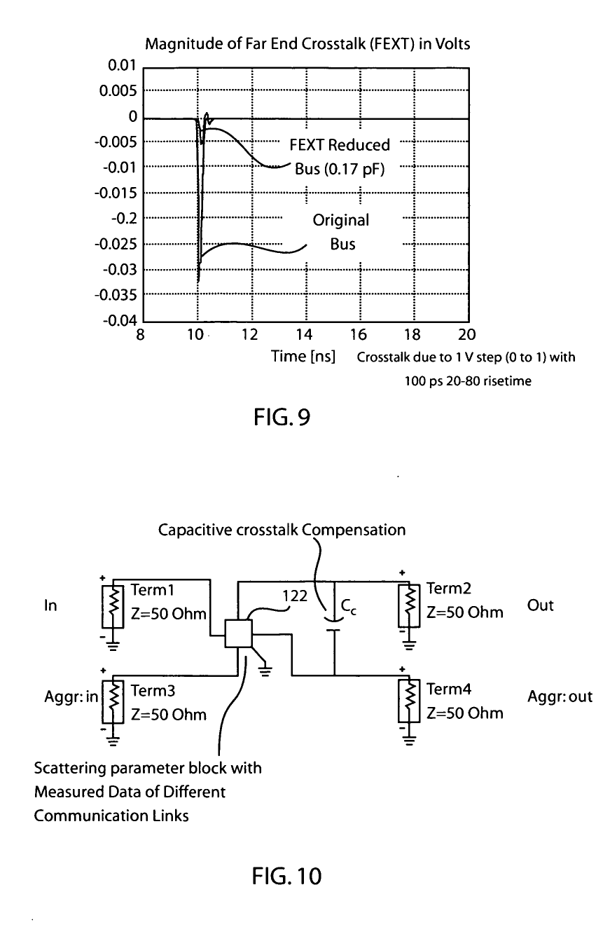

FIG. 9 shows voltage amplitude reduction in FEXT in time domain.

The compensation methods in accordance with aspects of the present invention provide crosstalk compensation that is global in nature as opposed to local compensation (see e.g., FIG. 3). Since electrical interconnects always have losses, the oscillations as exemplified in FIG. 8 are generally not a problem and can be controlled if necessary.

To show validity of the approach of the present invention, several single-ended data communication links comprising one aggressor interconnect and one victim interconnect have been measured in the frequency domain. These interconnects will be referred to hereinafter as stated in the following descriptions:
Bus I: 29 inch wiring on a printed circuit board (PCB), 2 connectors, 6 vias in the PCB;
Bus II: 4 inch wiring on a PCB, 2 vias in the PCB;
Bus III: 13 inch wiring on a PCB, 2 inch wiring on chip carrier, 2 connectors, 6 vias in the PCB; and
Bus IV: 4 inch wiring on a chip carrier.

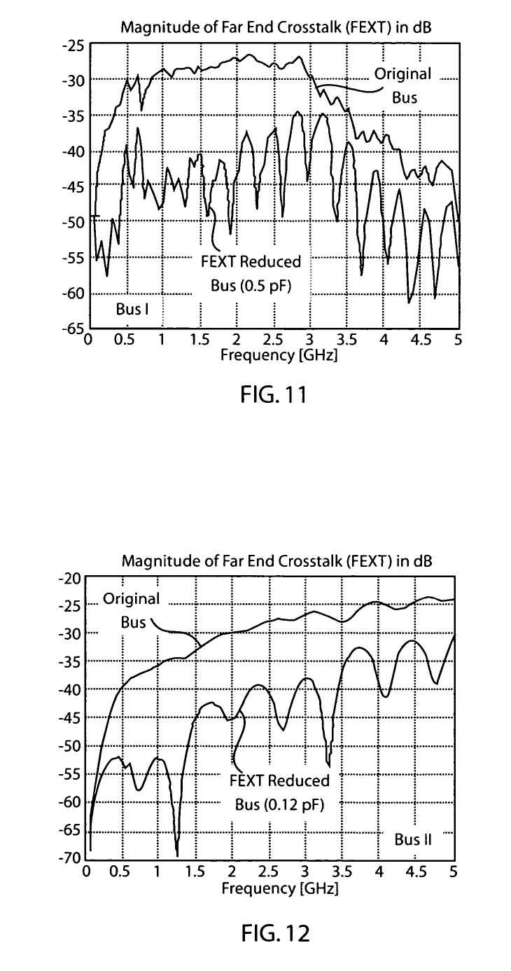

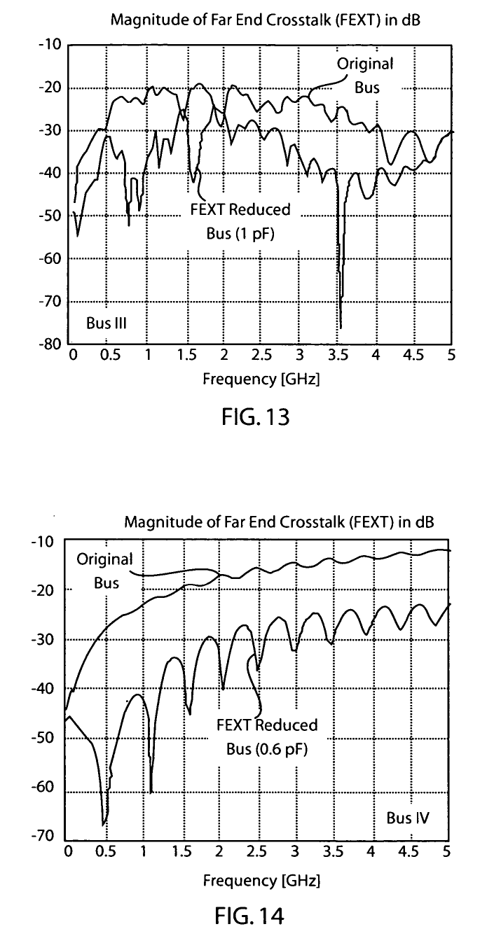

Referring to FIG. 10, global compensation was simulated in accordance with embodiments of the present invention employing a commercial circuit simulator in conjunction with measured scattering parameters (S-parameters) data stored in block 122. The simulator was employed to simulate measured data from a plurality of different communication links, namely, buses I, II, III, and IV. The results of the simulations are respectively shown in FIGS. 11, 12, 13, and 14. The simulation results prove the effectiveness of global crosstalk compensation in accordance with aspects of the present invention. In all cases the FEXT is lower using global compensation than in the original bus without compensation.

It should be noted that the capacitive compensation Cc in FIG. 10 had values at or below 1 pF which is well within the range that can be achieved on-chip.

The compensating capacitance Cc is preferably implemented on-chip on either the transmit or the receiver side. While Cc may also be implemented off-chip, the on-chip implementation offers the advantage of being able to tune the capacitance value by using, e.g., a varactor or other adjustment elements since tuning in a package or on a PCB would be difficult and costly.

Capacitive compensation Cc may be implemented on-chip and employ varactors or other adjustable elements to provide the ability to tune the capacitance (or inductance). Nonlinear dependence of capacitance on voltage may have to be factored into the design as well.

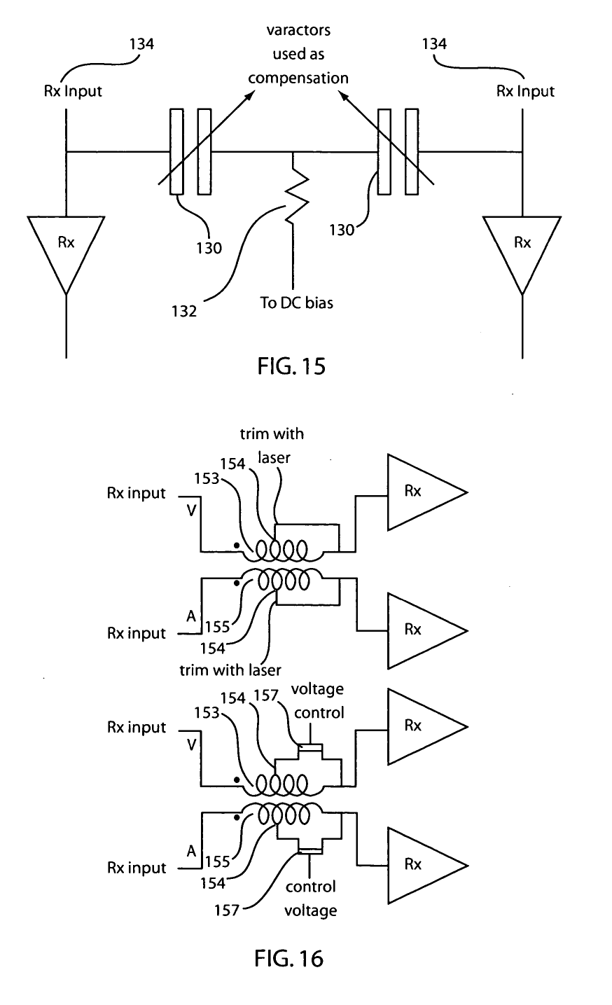

Referring to FIG. 15, an illustrative arrangement of varactors 130 is shown. The biasing of the varactors 130 may be performed in a plurality of ways. The biasing can most simply be done through a resistor 132 where the value of the bias resistor 132 is high compared to a termination impedance seen at a receiver input 134 corresponding to the varactor 130 (“Rx” stands for the receiver circuitry).

In the rare case of mainly capacitive package crosstalk, mutual inductance elements can be inserted as compensating elements.

FIG. 16 shows an arrangement of two on-chip spiral inductors 153 and 155 forming a mutual inductance (indicated by the black dots). A first inductor 153 is part of the crosstalk victim signal path (V) while the other inductor 155 is part of the crosstalk aggressor path (A). Both inductors—and hence their mutual inductance—can be made tuneable. This tuning can be accomplished by using lasers to trim connections to taps 154 of which there may be several to choose from although only one is shown in FIG. 16. Alternatively, as shown in FIG. 16, switch elements such as FETs (Field Effect Transistors) 157 which can be made conducting or non-conducting by applying a control voltage, can be used to electrically program the tap points. Inductive compensation may need more real estate if the values exceed, e.g., 1 nH. An alternative is to synthesize an inductive component using active devices. This can emulate an inductance in a much smaller area, and also permit tunability, albeit at some power dissipation penalty.

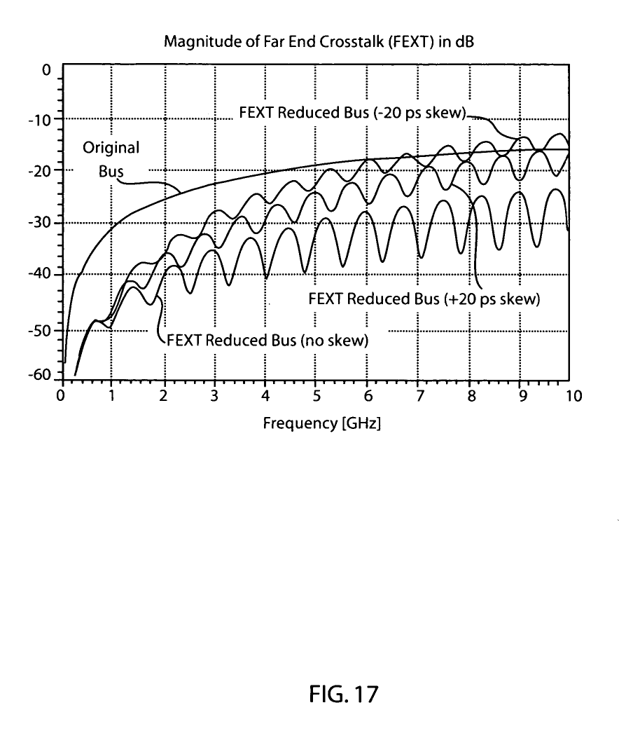

Skew control between the interconnects is one important consideration in the embodiments described herein. Skew control may include, e.g., tightly controlling the electrical length of the interconnects. This may include managing skew (e.g. by adding or taking away transmission line length in portions of an electrical path (e.g., in busses used on or between PCBs or chips, etc.)). Numerical studies of an electrical interconnect using a commercial circuit simulator have been performed to investigate the effect of skew and results are illustratively shown in FIG. 17.

Referring to FIG. 17, as can be seen, the FEXT reduction without skew is best, while a positive or negative skew between aggressor and victim interconnects degrades the reduction depending on frequency. In one embodiment, it is preferable to control skew below a threshold. For example, a threshold may be set at about half the 20%-80% edge rate of a signal such that less than or equal to half the 20%-80% edge rate of a signal is acceptable. For a 5 Gbps communication link with a 200 ps bit duration, this would mean less than 33 ps skew or approximately 1 cm of propagation in free space which is achievable with current interconnect technology.

It should be noted that the transmission, reflection, and near end crosstalk tend to deteriorate after introduction of a globally compensating element. However, in the applications studied, the gain in signal-to-noise ratio at the receiver input was always positive and hence the crosstalk compensation was beneficial. In general, a trade-off may be made. A balance can be chosen by adjusting the capacitance or inductance value along with needed levels of damping to avoid spurious oscillations in the frequency band of interest.

The type of crosstalk compensation provided in accordance with aspects of the present invention can be extended to an arbitrary number of interconnects in an electrical bus or to differential signaling by choosing the appropriate compensation topology and by careful adjustment of coupling factors for this compensation topology. This also includes the case of compensation of mainly capacitive crosstalk by an inductive element.

As an alternative to on-chip compensation, crosstalk compensating components can also be incorporated into the package at some level (either printed circuit board level, or in the chip carrier). To be practical, high dielectric constant plane layers would preferably need to be available for compensating capacitors. Inductors can be printed in the wiring (e.g., in copper) for larger values, or the intrinsic inductance in a via can be enhanced by tuning the design of the anti-pads in the printed circuit board and by using narrower drill diameters. In this case tunability is possible with trimming techniques, but will incur cost penalties and restrictions on the layout of the packages.

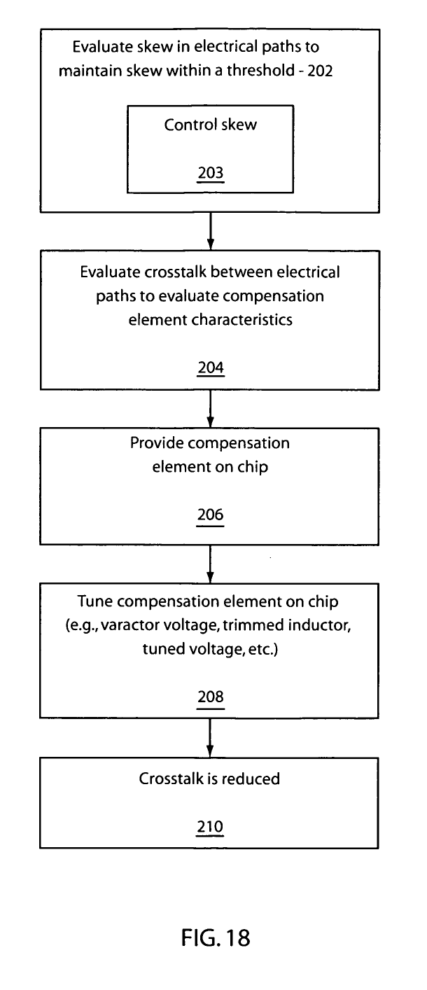

Referring to FIG. 18, a method for crosstalk compensation is illustratively presented. In block 202, skew is evaluated to ensure that the skew between electrical paths is substantially equal and maintained within an acceptable level. The skew may depend on the electrical paths themselves; however, skew may be maintained to be less than or equal to half the 20%-80% edge rate of a signal. This step may be omitted when the electrical paths are known to be matched based on skew. For example, the evaluation of the skew may include simply ensuring that skew is balanced between an aggressor/victim pair. This may include measuring skew or using elements where skew is known to be equalized.

Block 202 may include controlling skew by employing electrical paths having electrical lengths substantially equal in block 203. This may include keeping tight control over electrical lengths of the paths, or elements that may cause delays in signal propagation, etc.

In block 204, crosstalk between electrical paths may be evaluated to determine the characteristics of a global compensation element that may be needed. Since the global crosstalk compensation element can be placed anywhere in the electrical path, it is advantageous to place this element on a chip which is in the victim and aggressor electrical paths. In block 206, the global crosstalk compensation element integrated on the chip is provided. The compensation element globally compensates for crosstalk over all portions of electrical lengths of the electrical paths. The global crosstalk compensation element is preferably made out of simple passive elements, such as capacitors or inductors.

The compensation element is preferably adjustable/tunable and is tuned in block 208 in accordance with the crosstalk to be compensated in accordance with the electrical paths. Tuning the compensation element may include adjusting a varactor, by e.g., adjusting a biasing voltage to the varactor, adjusting an inductor by, e.g., laser trimming a tap connection, or programming the appropriate control voltages for the connecting field effect transistors (FETs) or other switches in FIG. 16. It should be understood that one of the many advantages of the present invention includes being able to set the global compensation element value of simple passive elements in advance for any set of elements where skew is reasonable matched, and the crosstalk will be significantly reduced. In block 210, crosstalk especially FEXT is reduced globally over the victim and aggressor electrical paths.

Having described preferred embodiments of a system and method (which are intended to be illustrative and not limiting), it is noted that modifications and variations can be made by persons skilled in the art in light of the above teachings. It is therefore to be understood that changes may be made in the particular embodiments disclosed which are within the scope and spirit of the invention as outlined by the appended claims. Having thus described aspects of the invention, with the details and particularity required by the patent laws, what is claimed and desired protected by Letters Patent is set forth in the appended claims.

What is claimed is:

1. A method for crosstalk compensation, comprising:
evaluating skew for lengths of at least two electrical paths;
providing an integrated circuit coupled to the at least two electrical paths, the integrated circuit including a global crosstalk compensation element integrated therewith which globally compensates for crosstalk on all lengths of portions of the two electrical paths.

2. The method as recited in claim 1, further comprising evaluating crosstalk between the at least two electrical paths to determine characteristics of the global crosstalk compensation element.

3. The method as recited in claim 1, wherein the global crosstalk compensation element is adjustable and further comprising adjusting the global crosstalk compensation element.

4. The method as recited in claim 1, wherein the global crosstalk compensation element includes a varactor and further comprising adjusting the varactor to tune the global crosstalk compensation element.

5. The method as recited in claim 4, wherein adjusting the varactor includes adjusting a biasing voltage to the varactor.

6. The method as recited in claim 1, wherein the global crosstalk compensation element includes a mutual inductance and further comprising adjusting the mutual inductance to tune the global crosstalk compensation element.

7. The method as recited in claim 6, wherein the mutual inductance is adjusted by laser trimming tap connections.

8. The method as recited in claim 6, wherein the mutual inductance is adjusted by electrically activating tap connections.

9. The method as recited in claim 1, wherein evaluating skew includes controlling skew by employing electrical paths having electrical lengths substantially equal.

10. A method for crosstalk compensation, comprising:
evaluating skew to maintain skew between two electrical paths below a threshold;
providing a chip coupled to the two electrical paths, the chip including a global crosstalk compensation element integrated therewith;
globally compensating for crosstalk over all portions of electrical lengths of the two electrical paths using the global crosstalk compensation element; and
tuning the global crosstalk compensation element in accordance with the two electrical paths.

11. The method as recited in claim 10, further comprising evaluating crosstalk between the two electrical paths to tune characteristics of the global crosstalk compensation element.

12. The method as recited in claim 10, wherein the global crosstalk compensation element includes a varactor and tuning includes adjusting the varactor.

13. The method as recited in claim 12, wherein adjusting the varactor includes adjusting a biasing voltage to the varactor.

14. The method as recited in claim 10, wherein the global crosstalk compensation element includes a mutual inductance and tuning includes adjusting the mutual inductance.

15. The method as recited in claim 14, wherein the mutual inductance is adjusted by laser trimming tap connections.

16. The method as recited in claim 14, wherein the mutual inductance is adjusted by electrically activating tap connections.

17. The method as recited in claim 10, wherein evaluating skew includes controlling skew by employing electrical paths having electrical lengths substantially equal.

18. A circuit, comprising:
at least two electrical paths;
an integrated circuit connected to the at least two electrical paths; and
a tunable global crosstalk compensation element integrated with the integrated circuit and connected to the two electrical paths, the global crosstalk compensation element being configured to globally compensate for crosstalk over all portions of electrical lengths of the two electrical paths whether the electrical lengths are on or off the integrated circuit.

19. The circuit as recited in claim 18, wherein the at least two electrical paths include a skew within a threshold.

20. The circuit as recited in claim 18, wherein the tunable global crosstalk compensation element consists of a single passive element.
